(19) United States
(12) Patent Application Publication
(10) Pub. No.: US 2014/0301084 A1
(43) Pub. Date: Oct. 9, 2014

(54) DEVICE FOR CHANGING LAMP COLOR TEMPERATURE

(71) Applicant: EXCELLENT IDEA CORP., The Valley (AI)

(72) Inventor: Chung-Chun YEN, Taichung (TW)

(73) Assignee: EXCELLENT IDEA CORP., The Valley (AI)

(21) Appl. No.: 13/904,148

(22) Filed: May 29, 2013

(30) Foreign Application Priority Data
Apr. 3, 2013 (TW) 102206242

(51) Int. Cl. F21V 13/14; F21V 17/02

(52) U.S. Cl. CPC F21V 13/14; F21V 17/02
USPC 362/284

(57) ABSTRACT

A device for changing lamp color temperature includes a lamp holder installed therein with a luminous source. A colored lens is set in front of the luminous source and a rotary mechanism is connected with the colored lens. The rotary mechanism functions to drive the colored lens to rotate to a first position where the colored lens is far away from the luminous source and to a second position where the colored lens obstructs the front side of the luminous source. By so designing, a user can adjust the position of the colored lens and choose either to let the light emitted by the luminous source project directly or to let the light first pass through the colored lens to change color temperature and then project, thus able to adjust lamp color temperature in accordance with various environments.

### BACKGROUND OF THE INVENTION

1. Field of the Invention

This invention relates to a device of lamp, particularly to one able to be rotated for changing the color temperature of light emitted by a lamp.

2. Description of the Prior Art

Generally, light of different color temperatures has different illumination characteristics. For instance, when color temperature is between 2300 k and 3800 k, the color of light color will be partially yellow and has better penetrating power, able to attain better illumination effect on a rainy day or in a foggy environment. When color temperature is over 4200 k, the color of light will become white, able to attain a brighter visual effect, but such light has no good penetrating power and hence is inapplicable to rainy days or foggy environment. Therefore; the inventor of this invention thinks that it is necessary to research and devise a kind of lamp that can be adjusted in color temperature according to different environments.

### SUMMARY OF THE INVENTION

The objective of this invention is to offer a device for changing lamp color temperature, which can be rotated to adjust color temperature suitable for use in accordance with different environments.

The device for changing lamp color temperature in the present invention includes a lamp holder oppositely formed with a front side and a rear side. The front side of the lamp holder is provided with a reflecting groove installed therein with a luminous source. A rotary mechanism is combined with the lamp holder, and a colored lens is positioned in front of the luminous source and connected with the rotary mechanism to be driven by the rotary mechanism to rotate relative to the luminous source and form a first position and a second position. When rotated to the first position, the colored lens is far away from the front side of the luminous source, and when rotated to the second position, the colored lens will obstruct the front side of luminous source.

The device for changing lamp color temperature in the present invention enables a user to adjust the colored lens to be at the first position or at the second position by means of the rotary mechanism so that the user can choose whether to let the light emitted by the luminous source project directly or let the light first pass through the colored lens to change color temperature and then project outward, able to adjust the lamp color temperature that is applicable to different environments.

### BRIEF DESCRIPTION OF DRAWINGS

This invention will be better understood by referring to the accompanying drawings, wherein:

FIG. 1 is a perspective view of a first preferred embodiment of a device for changing lamp color temperature in the present invention;

FIG. 2 is an exploded perspective view of the first preferred embodiment of the device for changing lamp color temperature in the present invention;

FIG. 3 is a schematic view of the first preferred embodiment of the device for changing lamp color temperature in a using condition in the present invention;

FIG. 4 is a schematic view of the first preferred embodiment of the device for changing lamp color temperature in another using condition in the present invention;

FIG. 5 is a plane view of a second preferred embodiment of a device for changing lamp color temperature in the present invention;

FIG. 6 is across-section view of a third preferred embodiment of a device for changing lamp color temperature in the present invention;

FIG. 7 is an exploded perspective view of a fourth preferred embodiment of a device for changing lamp color temperature in the present invention;

FIG. 8 is an exploded perspective view of a fifth preferred embodiment of a device for changing lamp color temperature in the present invention; and

FIG. 9 is a plane view of a sixth preferred embodiment of a device for changing lamp color temperature in the present invention.

### DETAILED DESCRIPTION OF THE PREFERRED EMBODIMENT

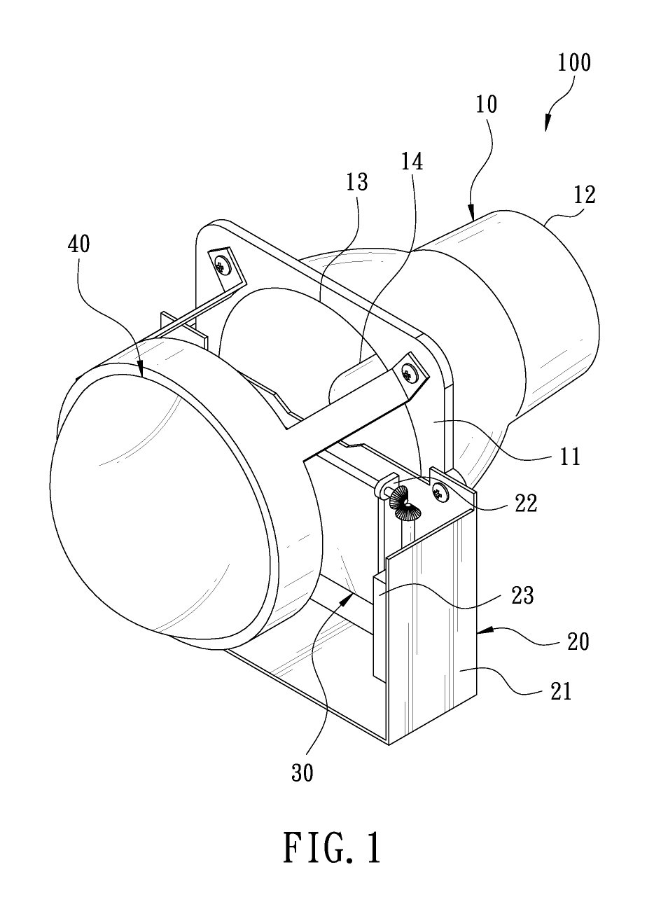

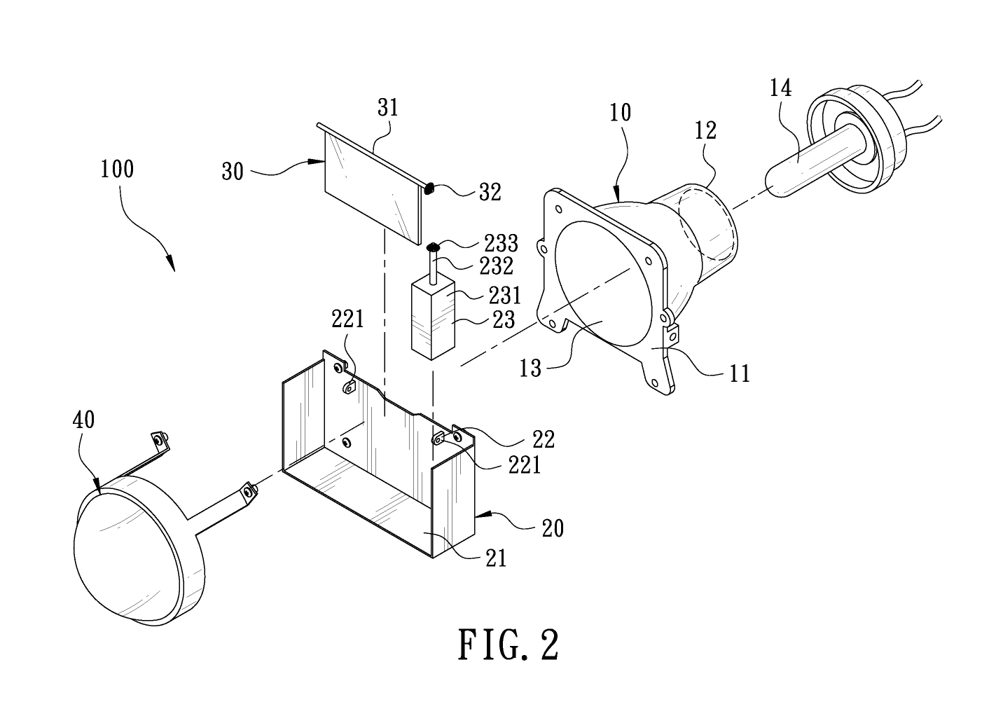

A first preferred embodiment of a device 100 for changing lamp color temperature in the present invention, as shown in FIGS. 1-4, includes a lamp holder 10, a rotary mechanism 20, a colored lens 30 and a lens 40 as main components combined together.

The lamp holder 10 is formed with a front side 11 and a rear side 12 opposite to the front side 11. The front side 11 of the lamp holder 10 is provided with a reflecting groove 13 installed therein with a luminous source 14, which is a lamp bulb.

The rotary mechanism 20 combined with the lamp holder 10 is formed with a stationary frame 21 provided thereon with a pivotal portion 22, which is a pair of lugs 221. The stationary frame 21 is further disposed with an actuator 23, which is a motor 231 having an output shaft 232 connected with a first gear 233.

The colored lens 30 positioned in front of the luminous source 14 and connected with the rotary mechanism 20 is provided thereon with a pivotal rod 31, which is parallel to one side of the colored lens 30 and has two ends respectively and pivotally combined with the two lugs 221, letting the pivotal rod 31 pivotally connected with the pivotal portion 22. Further, the pivotal rod 31 is connected with a second gear 32 that is engaged with the first gear 233, letting the pivotal rod 31 connected with the actuator 23.

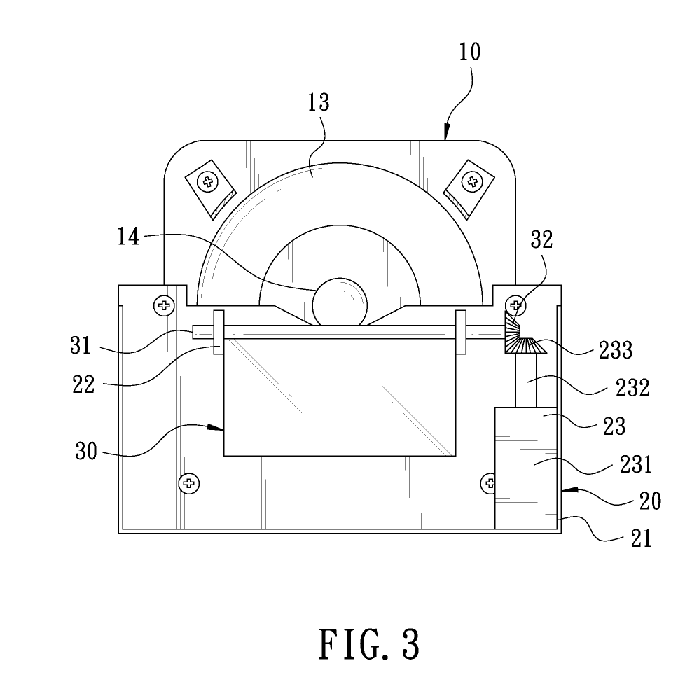

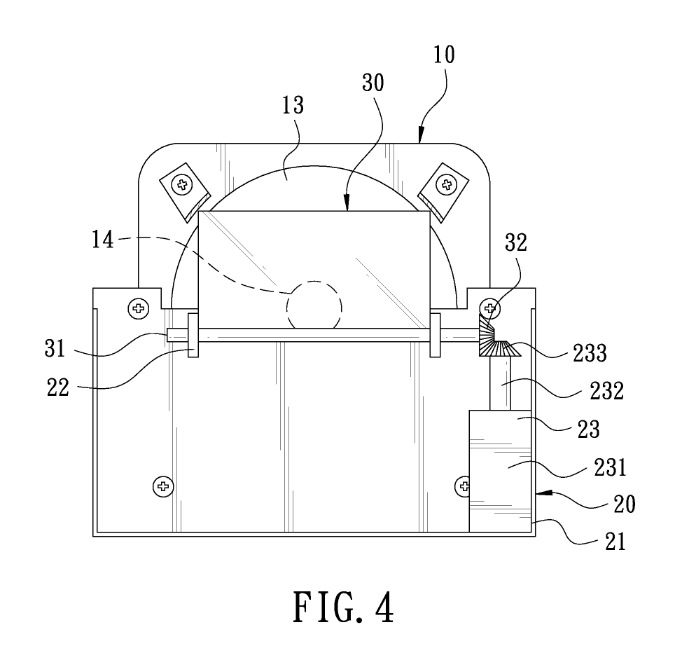

Thus, the colored lens 30, with the pivotal rod 31 serving as a central shaft, can be actuated by the rotary mechanism 20 to rotate relative to the luminous source 14 to form a first position, as shown in FIG. 3 and a second position, as shown in FIG. 4. When rotated to be at the first position, the colored lens 30 will be far away from the front side of the luminous source 14, while being at the second position, the colored lens 30 will obstruct the front side of the luminous source 14.

The lens 40 is fixedly assembled at the front side 11 of the lamp holder 10 and located in front of the colored lens 30.

In operating and using, referring to FIGS. 3 and 4, only start the actuator 23 to drive the output shaft 232 of the motor 231 to rotate. At this time, the first gear 233 of the output shaft 232 will actuate the second gear 32 of the pivotal rd 31 to rotate and drive the pivotal rod 31 to rotate to enable the colored lens 30 to carry out change-over between the first position and the second position. In the normal state, the colored lens 30 can be kept at the first position, as shown in FIG. 3, letting the light emitted by the luminous source 14 project directly toward the front side of the lamp holder 10. To change color temperature, simply have the rotary mechanism 20 driving the colored lens 30 to turn to the second position, as shown in FIG. 4, letting the light emitted by the luminous source 14 first pass through the colored lens 30 to change color temperature and then project toward the front side of the lamp holder 10. By so designing, applicable color temperature can be adjusted in accordance with different environments.

The following example explains the use of the device for changing lamp color temperature. The luminous source 14 can adopt a 6500 K high-intensity gas discharge lamp bulb while the colored lens 30 can employ yellow lens. Thus, in a normal state, the lamp color temperature changing device 100 can offer brighter illumination and in a dim environment due to rain or fog, the colored lens 30 can be turned to the second position to let the light pass through the colored lens 30 to be filtered by the colored lens 30 for changing the color temperature of the light, letting the light becomes yellow for increasing penetrability of the light.

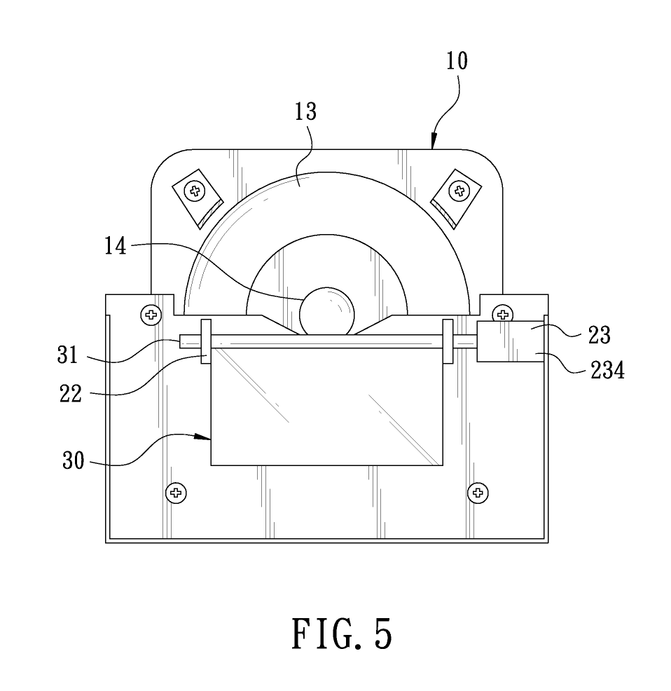

A second preferred embodiment of a device 100 for changing lamp color temperature in the present invention, as shown in FIG. 5, has almost the same structure as that described in the first preferred embodiment, except that a servo-motor 234 takes the place of the motor 231 of the actuator 23 and the servo-motor 234 is connected with the pivotal rod 31. When the servo-motor 234 is started to drive the pivotal rod 31 to rotate, the colored lens 30, with the pivotal rod 31 acting as a central pivot, can be rotated to be at the first position or at the second position, thus able to attain the effect described in the first preferred embodiment. Through adjustment of the position of the colored lens 30, a user can optionally let the light emitted by the luminous source 14 project directly or let the light first pass through the colored lens 30 to change color temperature and then project according to different environments. Moreover, the servo-motor 234 is installed therein with a decelerating mechanism (not shown) for enhancing rotational stability of the pivotal rod 31, the decelerating mechanism being a conventional element and unnecessary to make a superfluous statement.

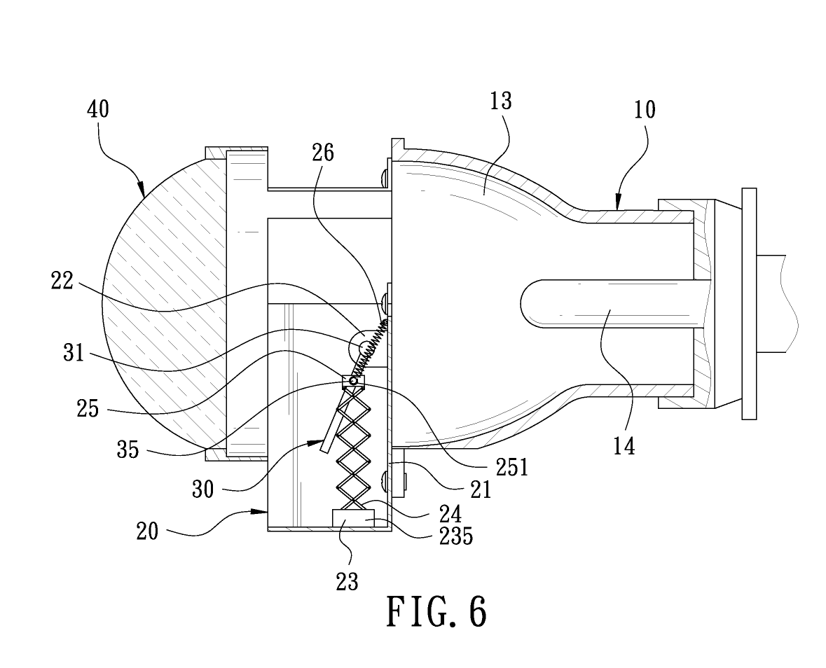

A third preferred embodiment of a device for changing lamp color temperature in the present invention, as shown in FIG. 6, is almost the same in structure as that described in the first preferred embodiment, except that the actuator 23 is an electromagnet 235 that is connected with a contractible coupling shaft 24 having another end fixed thereon with an iron block 25. The iron block 25 is bored with a connecting hole 251 while the colored lens 30 is provided with a connecting post 35 to be pivotally combined with the connecting hole 251, and an elastic piece 26 has one end connected with the stationary frame 21 and another end connected with the connecting post 35. Thus, when electrically connected, the electromagnet 235 will attract the iron block 25 and compel the iron block 25 to move close to the electromagnet 235 and actuate the colored lens 30 to rotate to the first position, with the pivotal rod 31 serving as a central pivot. When the electromagnet 235 is electrically disconnected, the colored lens 30 will be pulled by the elastic piece 26 to rotate reversely to be at the second position. Thus, the colored lens 30 in the third preferred embodiment equally can be adjusted in position to enable a user to choose whether to let the light emitted by the luminous source 14 project directly or to let the light first pass through the colored lens 30 to change color temperature and then project in accordance with different environments.

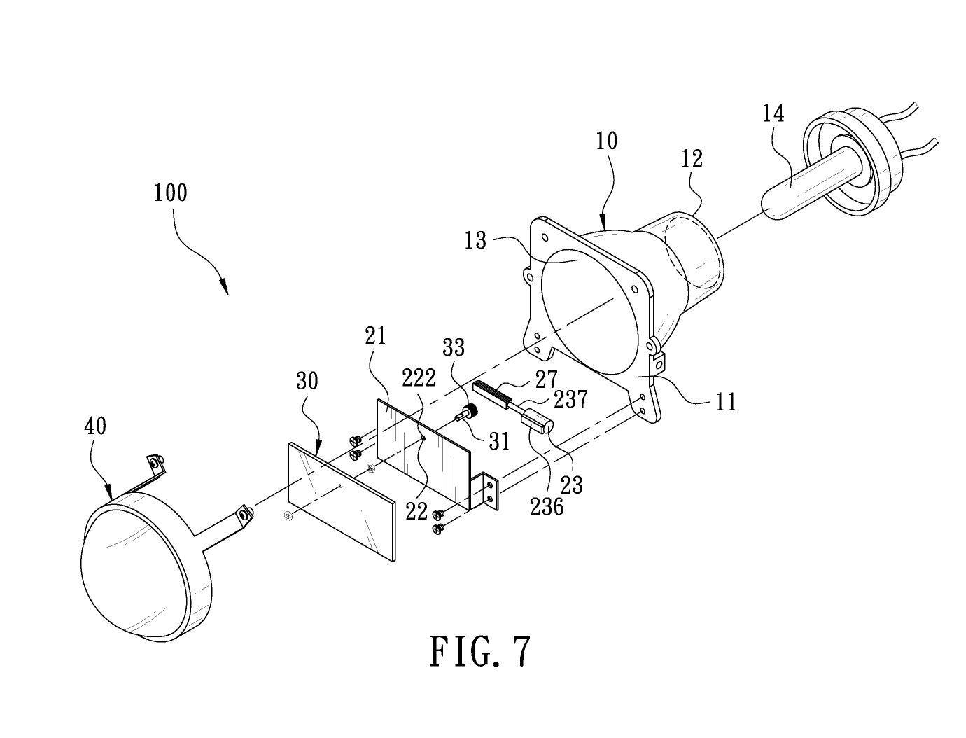

A fourth preferred embodiment of a device for changing lamp color temperature in the present invention, as shown in FIG. 7, has a difference from the first preferred embodiment that has a pivotal hole 222 taking the place of the pivotal portion 22 of the fixing frame 21 and a pressure cylinder 236 substituting for the actuator 23. The pressure cylinder 236 is provided with a telescopic rod 237 that is connected with a rack 27, and the pivotal rod 31 of the colored lens 30 is vertically positioned at one side of the colored lens 30 and has a free end pivotally fixed with the pivotal hole 222 and further connected with a third gear 33 that is meshed with the rack 27. Thus, the colored lens 30 having the pivotal rod 31 acting as a central pivot can be actuated by the telescopic rod 237 to rotate relative to the luminous source 14. By so designing, a user can adjust the position of the colored lens 30 to have an option of either letting the light emitted by the luminous source 14 project directly or letting the light first pass through the colored lens 30 to change color temperature and then project for meeting with different weather conditions.

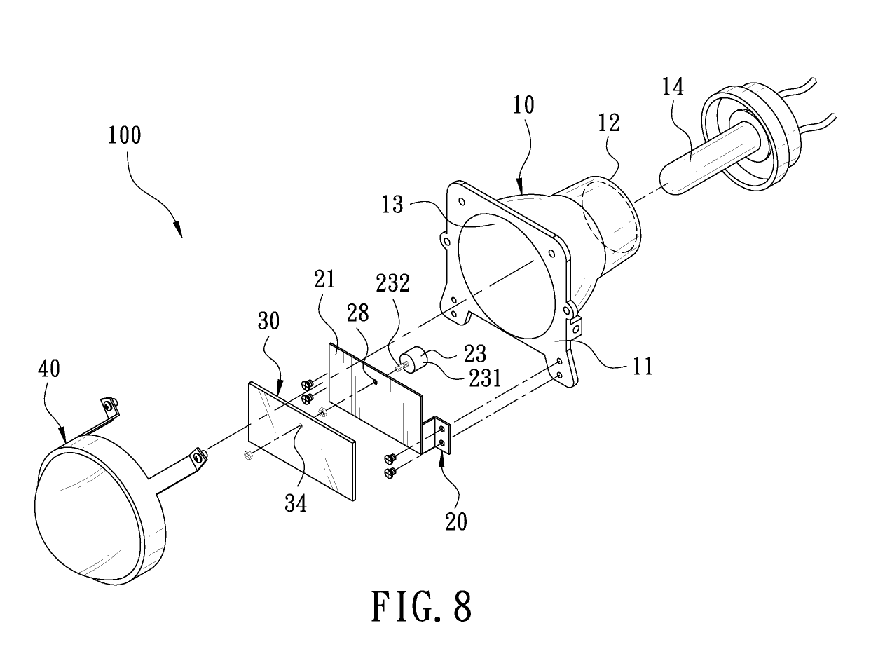

A fifth preferred embodiment of a device 100 for changing lamp color temperature in the present invention, as shown in FIG. 8, has a difference from the first preferred embodiment that has the stationary frame 21 bored with an insert hole 28 to replace the pivotal portion 22 and have the actuator 23 secured at one side of the stationary frame 21. The actuator 23 is a motor 231 having its output shaft 232 inserted through the insert hole 28, and the colored lens 30 is positioned at another side of the stationary frame 21 and bored with a through hole 34 corresponding to the insert hole 28 for the output shaft 231 to be inserted and fixed therein so that the colored lens 30, with the output shaft 232 acting as a central shaft, can be actuated by the output shaft 232 to rotate relative to the luminous source 14. Thus, a user is able to adjust the position of the colored lens 30 and decide either to let the light emitted by the luminous source 14 project directly or to have the light first passing through the colored lens 30 to change color temperature and then projecting outward and hence, the user can adjust the lamp color temperature suitable for use in different environments.

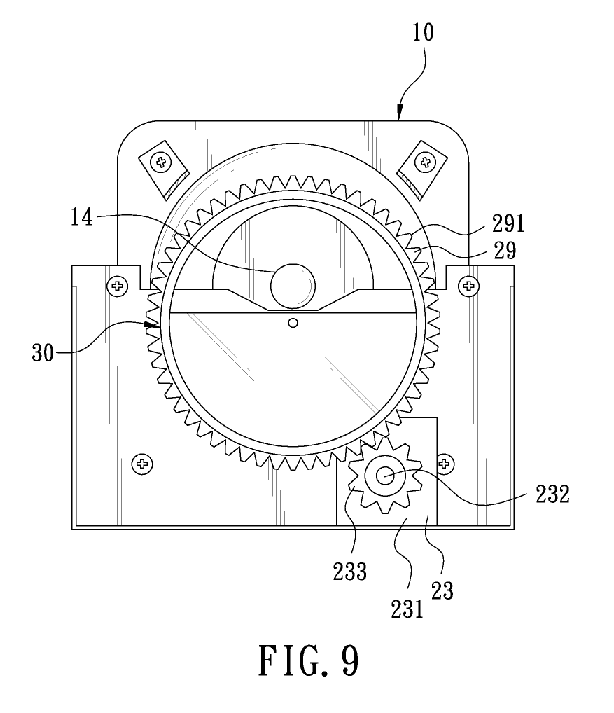

A sixth preferred embodiment of a device 100 for changing lamp color temperature in the present invention, as shown in FIG. 9, has a difference from the first preferred embodiment that has the stationary frame 21 pivotally mounted thereon with an outer frame 29 having an outer circumferential side circularly provided with a toothed portion 291, and the stationary frame 21 is disposed with an actuator 23, which is a motor 231. The output shaft 232 of the motor 231 is connected with the first gear 233 meshed with the toothed portion 291. When the outer frame 29 is driven to rotate by the motor 231, the colored lens 30 will be rotated together with the outer frame 29 to be at the first position and at the second position. Through position adjustment of the colored lens 30, a user can choose whether to let the light emitted by the luminous source 14 project directly or to let the light pass through the colored lens 30 first to change color temperature and then project, thus able to adjust lamp color temperature that is applicable to various environments.

While the preferred embodiments of the invention have been described above, it will be recognized and understood that various modifications may be made therein and the appended claims are intended to cover all such modifications that may fall within the spirit and scope of the invention.

What is claimed is:

1. A device for changing lamp color temperature comprising:
a lamp holder formed with a front side and a rear side opposite to said front side, said front side of said lamp holder provided with a reflecting groove, said reflecting groove having a luminous source installed therein;
a rotary mechanism combined with said lamp holder; and
a colored lens assembled in front of said luminous source and connected with said rotary mechanism, said colored lens driven by said rotary mechanism to rotate relative to said luminous source and form a first position and a second position, in case of said luminous source rotated to said first position said colored lens being far away from a front side of said luminous source, in case of said luminous source rotated to said second position said colored lens obstructing the front side of said luminous source.

2. The device for changing lamp color temperature as claimed in claim 1, wherein said rotary mechanism is formed with a stationary frame provided with a pivotal portion and an actuator, said colored lens provided with a pivotal rod, said pivotal rod pivotally combined with said pivotal portion, said pivotal rod connected with said actuator, with said pivotal rod acting as a central shaft said colored lens driven by said actuator to rotate relative to said luminous source.

3. The device for changing lamp color temperature as claimed in claim 2, wherein said pivotal portion is a pair of lugs, while said pivotal rod is parallel to one said of said colored lens, said pivotal rod having two ends respectively and pivotally fixed with said lugs.

4. The device for changing lamp color temperature as claimed in claim 3, wherein said actuator is a motor, said motor having an output shaft, said output shaft connected with a first gear, said pivotal rod of said colored lens connected with a second gear, said first gear and said second gear meshed with each other.

5. The device for changing lamp color temperature as claimed in claim 3, wherein said actuator is a servo-motor, which is connected with said pivotal rod.

6. The device for changing lamp color temperature as claimed in claim 3, wherein said actuator is an electromagnet, said electromagnet connected with a contractible coupling shaft, said coupling shaft having another end fixed with an iron block, said iron block bored with a connecting hole, said colored lens provided thereon with a connecting post corresponding to said connecting hole, said connecting post pivotally fixed in said connecting hole, an elastic piece having one end connected with said stationary frame and another end connected with said connecting post.

7. The device for changing lamp color temperature as claimed in claim 2, wherein said pivotal portion is a pivotal hole, and said pivotal rod is vertically arranged at one side of said colored lens, said pivotal rod having a free end pivotally fixed in said pivotal hole.

8. The device for changing lamp color temperature as claimed in claim 7, wherein said actuator is a pressure cylinder, said pressure cylinder provided with a telescopic rod, said telescopic rod connected with a rack, said pivotal rod connected with a third gear, said third gear meshed with said rack.

9. The device for changing lamp color temperature as claimed in claim 1, wherein said rotary mechanism is formed with a stationary frame, said stationary frame bored with an insert hole, said stationary frame having one side mounted with an actuator, said actuator being a motor, said motor having an output shaft, said output shaft inserted through said insert hole, said colored lens positioned at another side of said stationary frame, said colored lens bored with a through hole corresponding with said insert hole for said output shaft to be inserted and fixed therein, with said output shaft acting as a central shaft said colored lens driven by said output shaft to rotate relative to said luminous source.

10. The device for changing lamp color temperature as claimed in claim 1, wherein said rotary mechanism is formed with a stationary frame, said stationary frame pivotally mounted thereon with an outer frame, said outer frame having an outer circumferential side annularly provided with a toothed portion, said stationary frame installed thereon with an actuator, said actuator is a motor, said motor having an output shaft, said output shaft connected with a first gear, said first gear meshed with said toothed portion.
